(19) United States
(12) Patent Application Publication
(10) Pub. No.: US 2024/0121149 A1
(43) Pub. Date: Apr. 11, 2024

(54) Method and device for controlling a local area network

(71) Applicant: ORANGE, Issy-les-Moulineaux (FR)

(72) Inventors: Fabrice Fontaine, CHATILLON CEDEX (FR); Xavier Le Guillou, CHATILLON CEDEX (FR)

(21) Appl. No.: 18/475,460

(22) Filed: Sep. 27, 2023

(30) Foreign Application Priority Data
Sep. 30, 2022 (FR) 2209977

(51) Int. Cl. H04L 41/0654; H04W 24/08

(52) U.S. Cl. CPC H04L 41/0654; H04W 24/08; H04W 84/12

(57) ABSTRACT

A method and a device for monitoring a local area network administered by an access point of the network. The network includes a plurality of terminals. The method includes: acquiring at least one status parameter, called global parameter, including at least one datum representing an operation of the network; detecting a malfunction of the network as a function of the at least one global parameter; and triggering at least one countermeasure action in the event of a malfunction.

### FIELD OF THE DISCLOSURE

The invention relates to the general field of telecommunications. More specifically, it relates to monitoring the stability of a local area network.

### BACKGROUND OF THE DISCLOSURE

Radio technologies, notably Wi-Fi technologies, are increasingly used within a local area network, whether this is a home or business network. These technologies allow smartphones, cameras, drones, sensors and even all sorts of terminals grouped together under the acronym IoT (Internet Of Things) to be connected. Although these technologies have many advantages, they also have weaknesses associated with the very nature of the transmission medium. Indeed, the network is shared between all the terminals of the access point. A faulty terminal can prevent the “normal” operation of the other terminals, for example, by monopolising the bandwidth, which can lead to intermittent interruptions in the video and audio streams of the local area network.

Solutions are known for limiting such disruptions.

“Smart Wi-Fi”, for example, automatically detects and modifies Wi-Fi channels in a disruptive environment (a building, an office, etc.). The aim of such a technique is to share the radio channel as effectively as possible between the various terminals of the various access points of a network. For example, if a network has a gateway and a repeater capable of communicating over a plurality of different channels (frequencies), the smart Wi-Fi driver can place the gateway and the repeater on the least saturated channel, and can smartly distribute the terminals between the gateway and the repeater and/or over the various frequency bands, as a function of the expected performance and the congestion of the channels.

However, no solution exists for managing faulty or disruptive terminals of such a network.

Therefore, a need exists for a simple solution for preventing the disruption of a local area network due to the failure of a terminal.

### SUMMARY

Advantageously, a method according to an exemplary aspect of the present disclosure detects the disruption of a local area network and implements countermeasures.

The term “access point” is understood herein to mean any routing element capable of creating a local area network, for example, a Wi-Fi network: gateway, mobile terminal set up as a hotspot, router, etc. Hereafter, this element is called gateway and denotes the access point of a local area network.

The term “terminal” of the network is understood to mean a terminal that has connected to the gateway of the local area network at least once. Therefore, it is “known” to the gateway, irrespective of its current status: it actually can be connected to the gateway, or can be disconnected. It also can be connected to a network repeater. The terminal can be of any type, as long as it is capable of communicating on the local area network.

The term “status parameter” is understood to mean a datum or set of data that includes an indication relating to an operating parameter of the network: bandwidth, latency, saturation, jitter, packet loss, etc.

The term “malfunction” is understood to mean a problem communicating over the network, namely, packet loss, increase in latency, refusal to connect a new terminal, etc.

The term “countermeasure” is understood to mean an action of the monitoring method for rectifying the malfunction, such as, for example, disconnecting or blocking a disruptive terminal, sending a message to notify the administrator of the malfunction, etc.

According to some embodiments:
the global parameter comprises at least one datum representing an operation of the network from among:
signal quality;
latency;
throughput;
data packet loss;
coverage rate.

Advantageously, the global parameter comprises one or more data that are easily accessible by the administration of the local area network. They can be combined together.

They can relate to one or more terminals, one or more channels, etc.
Identifying a malfunction is preceded by comparing at least one datum of the global parameter with a threshold.

Advantageously, simple thresholding of an operating parameter can be carried out: for example, if the measured latency is greater than 10 seconds, a global malfunction can be identified.
Identifying a malfunction is followed by a step of identifying a terminal, called disruptive terminal, at least responsible for the malfunction.
The step of triggering a countermeasure action is directed against said at least one disruptive terminal.
The step of triggering a countermeasure action depends on a type of detected malfunction.
The step of triggering a countermeasure action depends on a type of the detected disruptive terminal.
The step of triggering a countermeasure action is followed by a step of acquiring an updated value of said global parameter and of cancelling said countermeasure action as a function of said at least one updated global parameter.

Advantageously, detecting a global malfunction allows the responsible terminal to be found in order to take a countermeasure. This countermeasure advantageously can be adapted to the type of malfunction detected: thus, for example, if the malfunction indicates an excessive throughput on a Wi-Fi channel, it may be advisable to switch the terminal responsible for the disruption to another channel, in order to provide it with a more suitable throughput and to stop disrupting the other terminals of this channel. If the detected malfunction is potentially linked to an attack on the terminal, it may be advisable to change its MAC address or to disconnect it from the local area network. If the detected malfunction is linked to a packet loss, it may be advisable to increase the power of the signal.

This countermeasure advantageously can be adapted to the type of terminal that is detected: if the terminal is a digital set-top box (STB), it may be advisable to switch it to a channel offering higher throughput. If the terminal is an unprotected object, it may be advisable to change its address in order to protect it from an attack.

Advantageously, a countermeasure action can be cancelled if the status of the network improves.

The countermeasure step against said at least one disruptive terminal comprises an action from among:
sending a notification message;
disconnecting the disruptive terminal;
reassigning a Wi-Fi channel for the disruptive terminal;
reassigning an access point for the disruptive terminal;
modifying the address of the disruptive terminal;
reassigning a Wi-Fi channel for at least one terminal other than the disruptive terminal;
deactivating a Wi-Fi function of the network;
increasing the power of the signal transmitted by the access point;
increasing the bandwidth over at least one channel;
activating a new antenna on the service gateway.

Advantageously, one or more countermeasures can be implemented. The countermeasures can be used successively or in combination. The countermeasures can be general (increasing the bandwidth) or specific to a terminal.

Correspondingly, an aspect of the present disclosure also relates to a monitoring device according to Claim 11.

The features and advantages of the monitoring method similarly apply to the monitoring device according to the disclosure, and vice versa.

Correspondingly, an aspect of the present disclosure also relates to a gateway comprising such a monitoring device.

A further aim of an aspect of the present disclosure is a computer program on a recording medium, with this program being able to be implemented in a computer or a monitoring device in accordance with the invention. This program includes instructions adapted to implementing the corresponding method. This program can use any programming language, and can be in the form of source code, object code, or of intermediate code between source code and object code, such as in a partially compiled format, or in any other desirable format.

An aspect of the present disclosure also relates to a computer-readable information medium or a computer-readable storage medium comprising instructions of a computer program as mentioned above. The information or recording media can be any entity or device capable of storing the programs. For example, the media can comprise a storage means, such as a ROM, for example, a CD-ROM or a microelectronic circuit ROM, or even a magnetic recording means, for example, a floppy disk or a hard disk or a flash memory. Moreover, the information or recording media can be transmissible media such as an electrical or optical signal, which can be routed via an electrical or optical cable, via a radio link, via a wireless optical link or via other means.

The program according to an aspect of the present disclosure notably can be downloaded over a network of the Internet type.

Alternatively, each information or recording medium can be an integrated circuit, in which the program is incorporated, with the circuit being adapted to execute or to be used to execute a method according to an aspect of the present disclosure.

### BRIEF DESCRIPTION OF THE DRAWINGS

Further features and advantages of one or more aspects of the present disclosure will become apparent from the following description, with reference to the accompanying drawings, which illustrate non-limiting embodiments and in which:

FIG. 1 illustrates an architecture of a communications network in which a monitoring device can be implemented;

FIG. 2 is a flow chart representing the steps of a monitoring method, implemented according to a particular embodiment;

FIG. 3 illustrates a functional architecture of a monitoring device.

### DESCRIPTION OF THE EMBODIMENTS

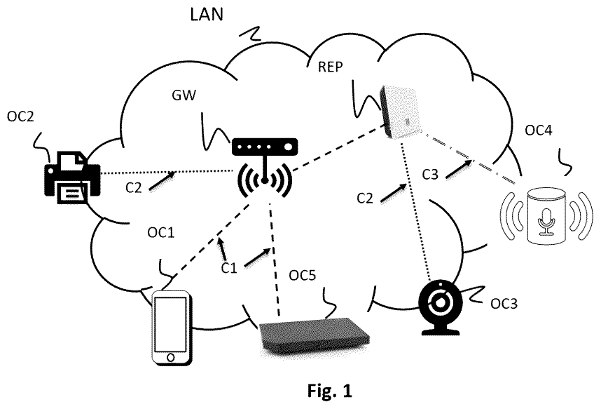

FIG. 1 illustrates an architecture of a communications network in which a system for monitoring a local area network as proposed can be implemented. According to this particular example, the method and the monitoring device are located on the network gateway GW.

The local area network (LAN) is an IP (Internet Protocol) local area network, for example, and the data packets are exchanged via the TCP/IP protocol. According to this example, the network (LAN) comprises a network management element (GW) called “access point” or “service gateway” or more simply “gateway” hereafter, and terminal equipment (OCi) connected to this local area network that is capable of establishing mutual communications via the gateway. The gateway also can be broadly considered to be a terminal of the local area network. It is, for example, a home gateway known commercially as a “Livebox”. It comprises a Wi-Fi communication function, or access point, that allows it to communicate with the terminals of the wireless network. By way of a reminder, the term Wi-Fi covers a set of standards in the IEEE 802.11 specification for wireless communications of up to a few hundred metres. Within the context of Wi-Fi, in order to connect to the gateway, a terminal must be paired using a pairing mechanism that is well known to a person skilled in the art.

Wi-Fi communications can use frequencies in different bands: 2.4, 5 GHz or 6 GHz. Each frequency band itself can be divided into channels. In the 2.4 GHz band, for example, there are 14 possible channels. Each channel comprises a central frequency, around which the useful signal is modulated in a frequency range of 20 to 22 MHz. These channels may or may not overlap. The fact that channels overlap causes interference between two terminals using two distinct but overlapping channels. The signal from one is seen as a disruptive signal, which can reduce the performance of the communication of the two terminals, and more generally of the network as a whole. Furthermore, in a high-density area where several Wi-Fi access points are present, the same channels can be used by two different local area networks, which can lead to the disruption of one or of both of the local area networks. Such a problem notably can be encountered in inhabited areas where several home gateways or Wi-Fi repeaters/extenders or other Wi-Fi access points of different users are very close to each other.

Alternatively, the access point could be a smart router, a hub, a mobile terminal set up as a hotspot, etc.

The local area network further comprises a repeater (REP). A Wi-Fi repeater is known as a device in the form of a box, which, when placed in the Wi-Fi coverage area of the gateway, broadcasts the signal to a poorly covered area of the local area network. The repeater acts as a second gateway with the same identifiers.

In addition to the gateway GW and the repeater REP, the network LAN shown comprises terminals OC1, OC2, OC3, OC4 and OC5. In the example described herein, the terminal OC1 is a smartphone, the terminal OC2 is a printer, the terminal OC3 is a camera, the terminal OC4 is a connected enclosure and the terminal OC5 is a digital set-top box (STB). They are able to communicate over the local area network via the gateway GW according to Wi-Fi standards. In the proposed example, the terminals OC3 and OC4, which are remote from the gateway (for example, they are on the upper floor of a house, whereas the gateway is on the ground floor), are connected to the repeater REP, whereas the terminals OC1, OC2 and OC5 are directly connected to the gateway GW. In the example in FIG. 1, the gateway uses 3 frequency channels, C1, C2 and C3, with the following central frequencies: 5.0, 2.417 and 2.422 GHz, respectively. The printer OC2 and the camera OC3 (via the repeater) are connected on channel 2, the terminals OC1 and OC5 are connected on channel 1 and the connected enclosure OC4 is connected on channel 3.

Each of the terminals OC1 of the local area network comprises at least one identifier MACi allowing the gateway to uniquely identify it in the local area network. This notably can be its MAC (Media Access Control) address. According to an alternative embodiment, the terminal identifier can be an IP address, or a UUID (Universally Unique Identifier), for example, in the case of a Bluetooth protocol, or an IMSI (International Mobile Subscriber Identity, etc.). The MAC address can be modified by the gateway, notably if it detects an attack-type malfunction (a spy terminal or hacker has appropriated the address of the local area network terminal).

In the example shown, the gateway GW is able to monitor the local area network as a whole so as to detect and rectify a global fault caused by one of the terminals OCi. The term “global” is understood herein to mean that the faulty terminal disrupts at least one terminal in the network other than itself (for example, the gateway, or a neighbouring item of equipment, or all the terminals of a segment of the network, or a certain type of terminals, or the terminals located beyond a certain distance, etc.).

According to one example, the equipment OC3 (the camera) is at the end of the network range and disrupts it by repeatedly sending packets of video data, causing saturation of the bandwidth. This saturation can affect the communications with the repeater, or the communications of the network as a whole, or channel C3, or by overflowing one of the other channels, etc.

According to other examples, the equipment OC3 is subjected to a radio attack by malicious equipment that transmits data packets in its place, or malfunctions following an incorrect software update of its Wi-Fi driver, or mismanages roaming between two Wi-Fi frequency bands, etc.

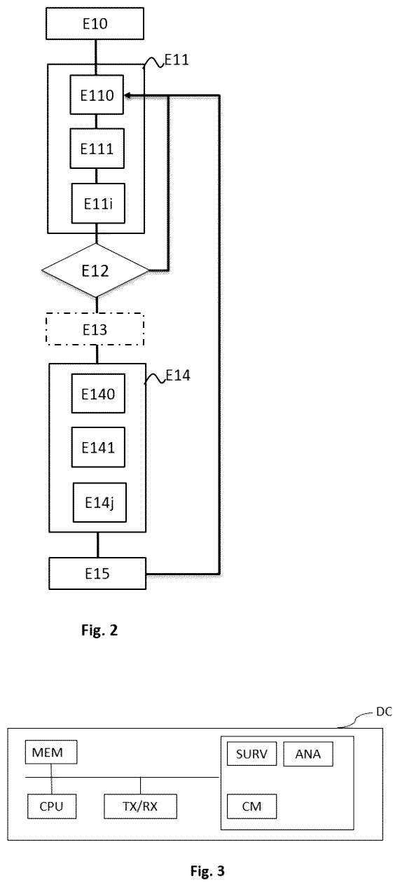

FIG. 2 is a flow chart showing the steps of a method for monitoring a Wi-Fi network, in accordance with an aspect of the present disclosure, implemented according to a particular embodiment by the monitoring system described with reference to FIG. 1. According to this embodiment, the gateway GW is responsible for the monitoring method.

According to another embodiment, the device and the method can be located on a Wi-Fi repeater (REP).

According to another embodiment, the device and the method can be located on any terminal, for example, the smartphone (OC1).

According to another embodiment, the device and the method can be distributed between several terminals, for example, between the gateway GW and the repeater REP.

During a step E10, the gateway GW appropriates the list of terminals connected to the network. It is well known that a home gateway permanently maintains a table of the terminals associated therewith. This table is updated each time a pairing or connection/disconnection packet is received from a terminal. The (MAC) address of the terminals paired therewith and their status (disconnected, connected, communicating, etc.) are therefore stored in a memory.

During a step E11, the gateway initiates a step of monitoring IP/Wi-Fi traffic in order to detect a “global” disruption of the local area network, i.e., affecting more than one terminal. To this end, it measures various global parameters of the network, such as, for example, and in a non-limiting manner, the following parameters, which can be measured for a channel, or for a set of channels:
The quality or strength of the signal; for example, the RSSI (Received Signal Strength Indication) is a measure of the power level of a received signal (conventionally a radio signal). Its purpose is to provide an indication of the strength of the signal received from a terminal. Such strength is generally measured in dBm. An acceptable range of measured strength can range from 0 dBm (the best) to −70 dBm (the worst). The signal strength also can be assessed per channel, per terminal, or for a group of terminals. For example, the method measures the quality of all the frames received during a time interval. For example, the method measures the quality of the frames received by the repeater REP, which provides a quality measurement of the sub-network managed by the repeater REP. According to another example, the gateway computes the average RSSI of all the terminals connected thereto. It should be noted that some gateways already compute, in a known manner, the signal level of a terminal by averaging the RSSIs corresponding to the last received frames;
The number of data retransmissions. It should be noted that the TCP protocol operates in “connected” mode, which means that 2 communicating terminals ensure that their data is correctly received. This protocol uses the sequence and acknowledgement numbers of the received packets. When an acknowledgement is not received, the packet must be retransmitted. In the event of packet loss, the protocol therefore includes a mechanism for retransmitting lost frames. Such retransmissions of frames are often due to overloading of the network. The more packets are retransmitted and the greater the latency in the communications, the poorer the performances. For example, an average retransmission value of less than 10% can be considered to be acceptable;
The number of lost packets, or timeouts. After a certain number of attempts to retransmit a packet, the TCP communication stops. This is called timeout. The gateway can record the number of timeouts that have resulted in a communication failure. Furthermore, if a protocol other than TCP is used (for example, RTP or UDP), packets can be lost without necessarily stopping the communication;
Latency is also a useful parameter for monitoring the correct operation of the local area network. Latency is understood to mean the time period required to send a data packet to a destination and to receive an acknowledgement in return over the wireless network. High values adversely affect the performance of real-time applications, such as video conferencing. For example, acceptable latency values can be between 1 and 10 ms. For example, the method measures the latency of all the frames received during a time interval from a terminal, a group of terminals, a sub-network (that of the repeater REP), etc.;
Jitter is defined, for its part, as the variation in latency over time. Latency and jitter can be assessed on each terminal by a regular “ping” from the gateway to the terminal, i.e., by sending a test packet to the terminal and by observing the response time;
The network throughput, or load, which corresponds to the average rate of data transfers fully completed on a segment of the network. It is lower than the effective bandwidth, which corresponds to the highest possible throughput on a segment of the network. The throughput and the bandwidth are measured in kilobytes per second (KB/s) or MB/s. The theoretically higher the bandwidth value, the better the network performance. Very high use of this available bandwidth, and therefore a very high load, can indicate a malfunction in one of the terminals. For example, acceptable bandwidth values can be above 5 MB/s; the maximum acceptable load can be 95%;
The overlap between the channels, which corresponds, as explained above, to the overlapping frequencies between two adjacent channels;
The overlap of the channels, which results, as explained above, from two different access points using the same channel (for example, the gateway of a neighbour, or a second gateway in the same home, or a second access point in a business network). With the proliferation of Wi-Fi networks, it is possible for an object OC3 of the LAN to malfunction on a Wi-Fi channel because the channel is being used by a neighbouring network;
Roaming between access points. When a terminal moves into an area equipped with several access points (for example, between the gateway GW and the repeater REP, or between a neighbouring gateway and the gateway GW), it sometimes needs to connect to a new access point on the same network in order to maintain communication quality. This capability is called roaming. If a terminal (OC3) on the network malfunctions, it can prevent roaming by another terminal attempting, for example, to connect to the repeater REP.

Step E11 is divided into as many sub-steps E11i (with i being variable) as there are parameters. For example, latency is analysed during a step E110, then RSSI is analysed during a step E111, etc.

On completion of step E11, the gateway monitoring device has, for example, the following table available in its memory, which table is provided by way of a non-limiting indication:

TABLE 1

| Channels | | OC1 | OC2 | OC3 | OC4 | OC5 | AV OK | MAX OK |
|---|---|---|---|---|---|---|---|---|
| C1 | LATENCY (s) | 1 | — | — | — | 5 | YES | YES |
| @5 GHz | RSSI (dB) | −25 | — | — | — | −45 | NO | NO |
| | RETRANS. (%) | 3 | — | — | — | 3 | YES | YES |
| | BP (MB/s) | 5 | — | — | — | 5 | YES | YES |
| | COVERAGE (%) | | | | | | | |
| | . . . | | | | | | | |
| C2 | LATENCY | — | 1 | 11 | — | — | YES | NO |
| @2.4 GHz | . . . | | | | | | | |
| C3 | LATENCY | — | — | — | 3 | — | YES | YES |
| @2.4 GHZ | . . . | | | | | | | |

In this example table, called status table, the 3 channels are analysed separately. The parameters used in this case are the latency (LATENCY, in seconds), the signal-to-noise ratio (RSSI, in dBm), the bandwidth (BP, in MB/s), the retransmission rate (RETRANS, as a percentage of packets retransmitted), and the coverage of one channel by another channel (COVERAGE, as a percentage of coverage). Other parameters could be taken into account, such as, for example, overlapping, jitter, roaming, etc.

In the status table shown, the average AV OK indicates whether an average malfunction has been detected on the considered channel. For example, if the minimum acceptable RSSI is −30 dbm, on channel C1, the average quality (of −35 dbm) is not acceptable. The average MAX OK indicates whether a malfunction has been detected on the considered channel for a given terminal. For example, if the maximum acceptable latency is 10 seconds, on channel C2, the average latency (6 seconds) is acceptable but the latency of the terminal OC3 (11 seconds) is not acceptable. Thus, depending on the criterion used, a malfunction may or may not be detected.

According to another embodiment, the channels are not distinguished during the measurement steps of step E11, i.e., the monitoring method carries out its measurements on received and/or transmitted frames without taking into account the relevant channel.

According to another embodiment, the terminals are not distinguished, i.e., the monitoring method carries out its measurements on received and/or transmitted frames without taking into account the relevant terminal.

According to one embodiment, step E11 is completed after a specified time from the start of the monitoring.

According to another embodiment, step E11 is completed as soon as an anomaly has been detected, i.e., one of the parameters has exceeded an authorised minimum (or maximum) threshold.

A test can be carried out during step E12 to determine whether or not there is a problem on the local area network. For example, the average and maximum values in Table 1 are compared with the maximum authorised thresholds for the considered parameter (for example, 10 seconds for latency).

If no disruption is detected on completion of step E12, the method stops or loops back to step E11. Step E11 can continue as a background task to update the monitoring table.

If a disruption is detected during step E12, according to the example shown, the gateway has detected a disruption, called global disruption (i.e., one that disrupts more than one network terminal).

During an optional step E13, in the event of global disruption, the gateway searches for the terminal causing the disruption.

According to one embodiment, the disruptive terminal is the one with a retransmission rate (respectively timeout, latency, jitter, etc.) that is too high, and this value is already known to the gateway. According to an example provided above in Table 1, it is the terminal OC3, which has very high latency, that is disrupting the channel C2, and hence the local area network. The disruptive terminal is thus identified directly.

According to one embodiment, the gateway carries out a temporal analysis of the gathered data and draws a conclusion: for example, the disruption systematically occurs when the terminal OC3 is present, which is at the limit of its range. In this embodiment, precise measurements do not need to be taken of the various aforementioned parameters. The global parameter relates to the presence of the terminal (its connection to the local area network).

According to one embodiment, the gateway carries out an additional analysis to detect the one or more disruptive terminals. For example, it “PINGS” all the terminals to deduce the terminal with latency that is too high, if it has not already detected this terminal.

Step E13 can be omitted by implementing, in step E14, one or more general countermeasures, i.e., countermeasures that do not target a particular terminal, but aim to improve the operation of the network as a whole. These general countermeasures include, but are not limited to:
notifying the gateway user (administrator);
deactivating “advanced” Wi-Fi functions that could reduce the range, such as 6 or 5 GHz Wi-Fi;
deactivating “advanced” Wi-Fi functions that are known to have interoperability problems, such as protected management frames (PMF). PMFs are a standard defined by the Wi-Fi Alliance to improve the security of Wi-Fi connections;
increasing the power of the signal emitted by the access point;
activating an additional antenna on the access point;
etc.

During step E14, if a disruptive terminal (OC3) has been detected, the gateway implements one or more countermeasures to attempt to correct the disruption, these countermeasures include, but are not limited to:
“blocking” the disruptive terminal: connection refusal, quarantine, etc. For example, the terminal OC3 is disconnected so as not to disrupt the network;
creating a dedicated Wi-Fi network for the disruptive terminal; for example, the terminal OC3 is assigned to a new channel C4;
activating a Wi-Fi repeater function on a terminal close to the disruptive terminal; for example, the terminal OC3 is assigned to a new repeater;
notifying of disrupted terminals (for example, using the UpnP protocol) so that they leave the Wi-Fi and change the connection type: switch to Ethernet (for example, STB) or even to another radio protocol, such as Thread/ZigBee/Bluetooth;
changing the address (MAC, IP, etc.) of the disruptive terminal;
etc.

Step E14 is divided into as many sub-steps El4j as there are measures taken to rectify the malfunction. For example, the user is notified during a step E140, then the terminal OC3 is switched to another channel during a step E141, etc.

Then, in step E15, the monitoring method reassesses the situation after these countermeasures have been implemented. To this end, it can return to step E11 to analyse the status table available in its memory, which can be updated as a background task.

According to one embodiment, the global parameter is measured again. Depending on this value, a new decision can be taken according to the new status of the network.

If the situation does not improve, the gateway can take additional countermeasures.

Otherwise, if the situation improves, it can cancel the countermeasures. For example, if the disruptive terminal is disconnected and the signal strength is increased, the gateway can “cancel” the second countermeasure by reducing the power of the signal. Indeed, some countermeasures can significantly increase consumption or even restrict the quality of service. In this case, it is advisable to cancel them once the malfunction has been resolved (reduce the signal power, deactivate/reactivate the Wi-Fi functions, deactivate the Wi-Fi antennas that were activated during the countermeasure, etc.).

FIG. 3 shows a functional architecture of a monitoring device DC.

It comprises modules for measuring the operating parameters of the network, for detecting a malfunction, and rectifying them.

In the embodiments described herein, the device DC has the hardware architecture of a computer. Its hardware architecture notably comprises a processor CPU, a random-access memory and a read-only memory grouped together in a module MEM, optionally a non-volatile flash memory in a particular embodiment of the disclosure, as well as communication means TX/RX for transmitting and receiving messages on the Wi-Fi network. Such means are known per se and are not described in greater detail herein.

The random-access memory of the device is used to store variables used for executing the steps of the monitoring method according to an aspect of the present disclosure.

The read-only memory of the device forms a recording medium according to an aspect of the present disclosure, which can be read by the processor and on which a computer program according to an aspect of the present disclosure is recorded.

The computer program defines functional and software modules that in this case are configured to monitor the status of the network, to detect a malfunction and to take a countermeasure action. These functional modules rely on and/or control the hardware elements of the device.

In other embodiments, the device DC also comprises:
an analysis or monitoring module SURV configured to measure the status parameters of the network. It should be noted that this module already partially exists on all the access points: measurement of latency, bandwidth, etc.;
a module ANA for analysing the operating parameters and extracting a malfunction decision therefrom;
a module CM for implementing a countermeasure.

Although the present disclosure has been described with reference to one or more examples, workers skilled in the art will recognize that changes may be made in form and detail without departing from the scope of the disclosure and/or the appended claims.

1. A method for monitoring a local area network administered by an access point of the network comprising a plurality of terminals, the method being implemented by a monitoring device and comprising:
acquiring at least one status parameter, called global parameter, comprising at least one datum representing an operation of the network;
detecting a malfunction of the network as a function of said at least one global parameter, and
triggering at least one countermeasure action in the event of a malfunction.

2. The method according to claim 1, wherein the global parameter comprises at least one datum representing an operation of the network from among:
signal quality;
latency;
throughput;
data packet loss;
coverage rate.

3. The method according to claim 1, wherein identifying a malfunction is preceded by comparing at least one datum of the global parameter with a threshold.

4. The method according to claim 1, wherein identifying a malfunction is followed by identifying a terminal, called disruptive terminal, at least responsible for the malfunction.

5. The method according to claim 4, wherein the triggering a countermeasure action is directed against said at least one disruptive terminal.

6. The method according to claim 1, wherein triggering a countermeasure action depends on a type of detected malfunction.

7. The method according to claim 1, wherein triggering a countermeasure action depends on a type of the detected disruptive terminal.

8. The method according to claim 1, wherein triggering a countermeasure action is followed by:
acquiring an updated value of said global parameter; and
cancelling said countermeasure action as a function of said at least one global parameter.

9. The method according to claim 1, wherein the at least one countermeasure action comprises an action from among:
transmitting a notification message;
deactivating a Wi-Fi function of the network;
increasing the power of the signal transmitted by the access point;
increasing the bandwidth on at least one channel;
activating a new antenna on the service gateway.

10. The method according to claim 4, wherein the at least one countermeasure action comprises an action from among:
disconnecting the disruptive terminal;
reassigning a Wi-Fi channel for the disruptive terminal;
reassigning an access point for the disruptive terminal;
modifying an address of the disruptive terminal;
reassigning a Wi-Fi channel for at least one terminal other than the disruptive terminal.

11. A device for monitoring a local area network administered by an access point of the network comprising a plurality of terminals, the device comprising:
to implement:
at least one processor; and
at least one non-transitory computer readable medium comprising instructions stored thereon which when executed by the at least one processor configures the device to implement a method comprising:
acquiring at least one status parameter, called global parameter, comprising at least one datum representing an operation of the network;
detecting a malfunction of the network as a function of said at least one global parameter, and
triggering at least one countermeasure action in the event of a malfunction.

12. A network gateway comprising the device according to claim 11.

13. A non-transitory computer readable medium comprising a computer program comprising instructions stored thereon for executing a monitoring method for monitoring a local area network administered by an access point of the network comprising a plurality of terminals, when said program is executed by a computer, wherein the monitoring method comprises:
acquiring at least one status parameter, called global parameter, comprising at least one datum representing an operation of the network;
detecting a malfunction of the network as a function of said at least one global parameter, and
triggering at least one countermeasure action in the event of a malfunction.
